(19) United States
(12) Patent Application Publication
(10) Pub. No.: US 2003/0080599 A1
(43) Pub. Date: May 1, 2003

(54) Adjusting device for a rotational adjustment of two centrically mounted adapter elements, in particular for a seat, and planetary gear configuration

(76) Inventors: Bernd-Robert Hohn, Munchen (DE); Hubert Biehler, Kassel (DE)

Correspondence Address: LERNER AND GREENBERG, P.A., Post Office Box 2480, Hollywood, FL, 33022-2480, US

(21) Appl. No.: 10/272,388

(22) Filed: Oct. 15, 2002

Related U.S. Application Data
(63) Continuation of application No. PCT/EP02/01414, filed on Feb. 11, 2002.

(30) Foreign Application Priority Data
Feb. 12, 2001 (DE) 101 06 422.5
Mar. 5, 2001 (DE) 101 10 529.0

(51) Int. Cl. B60N 2/02; F16H 57/08

(52) U.S. Cl. 297/362; 475/331

(57) ABSTRACT

An adjustment device for a rotational adjustment of two centrically mounted adapter pieces especially for a seat, preferably for a seat of a motor vehicle, includes a planetary gear with a sun wheel and planetary wheels. The planetary gear has a first housing part and a second housing part each with an internal toothing. The housing parts can be rotated relative to one another and are captively held on one another. Both housing parts have an edge flange. A separate retaining ring, which overlaps the edge flanges, holds the housing parts together. This allows to assemble the adjustment device in a simple manner and at low cost and ensures that the adjustment device functions even when subjected to high stress.

### CROSS-REFERENCE TO RELATED APPLICATION

This application is a continuation of copending International Application No. PCT/EP02/01414, filed Feb. 11, 2002, which designated the United States and was not published in English.

### BACKGROUND OF THE INVENTION

1. Field of the Invention

The invention relates to an adjusting device for the rotational adjustment of two centrically mounted adapter elements, in particular for a seat, preferably for a seat of a motor vehicle, and to a planetary gear configuration.

A conventional adjusting device of this type is disclosed in German Patent No. DE 32 01 309 C2. In the case of this conventional adjusting device, the centrically mounted adapter elements are fitting tabs which are integrally constructed with a respective housing part. The adapter elements including the fitting tabs and the housing parts are deep-drawn parts, the planetary gear together with its two internal toothings being situated in the deep-drawn region. The two housing parts are fastened to each other via so-called retaining plates which have a step shape in cross section and are configured in the manner of a segment of a ring. These retaining plates are in each case fastened to a housing part, engage over a corresponding edge of the other housing part and extend over approximately 90°. The retaining plates serve not only to prevent the two housing parts from falling apart, but also to absorb the axial forces acting on the adjusting device.

Furthermore, German Patent No. DE 32 01 309 discloses a planetary gear of the generic type which is configured as an adjusting mechanism for adjustment of a backrest of a seat. A planetary gear of this type makes an adjustment possible at favorable transmission ratios and is subject to extensive self-locking. These are properties which are favorable in general for adjusting mechanisms, for example for the backrest adjustment referred to.

A disadvantage of the conventional adjusting device is that the latter can gape apart at high axial loads and ceases to function. The load can be brought about by forces acting axially from the outside on the fitting tab. Furthermore, the internal, very narrow gear wheels of the planetary gear can be very severely loaded radially and then yield. The most severe stress is produced if both types of load occur, namely the axial load from the outside and the radial load from the inside.

A further disadvantage of the conventional adjusting device is that the latter only permits an adjustment through approximately 180°. An adjustment beyond 180° is not possible, since the moveable fitting parts then strike in each case against the retaining plate fastened to the other fitting part. Although it is possible in principle to obtain an adjustment of the fitting parts of more than 180° by the retaining plates being shortened, i.e. extending over less than 90°, this has the consequence at the same time that the retaining plates are even less able to perform their function of absorbing corresponding forces acting on the adjusting device and of holding the housing parts together.

Finally, a further disadvantage of the conventional adjusting device is that the adjusting device together with its integrally formed fitting parts always has to be adapted to the respective application or different adjusting devices having different fitting parts have to be available for different uses.

An adjusting device of the type mentioned at the beginning is likewise revealed in Published, Non-Prosecuted German Patent Application No. DE 199 33 895 A1. In this case, the adjusting device is of modular construction. The gear wheels of the planetary gear are held in a housing. The adapter elements can be fitted onto this housing as the need arises. The construction of the housing of the conventional adjusting device is such that the one housing part has an edge flange and the other housing part has a crimped edge, and that the crimped edge is crimped around the edge flange. A first disadvantage of this conventional adjusting device is that different types of housing parts have to be used. A further disadvantage results from the fact that the housing part having the crimped edge has to be selected in terms of material such that crimping of the edge is possible in a simple manner. This is disadvantageous insofar as the rest of the housing has to be relatively stiff.

### SUMMARY OF THE INVENTION

It is accordingly an object of the invention to provide an adjusting device which overcomes the above-mentioned disadvantages of the heretofore-known adjusting devices of this general type and which can be universally used, and which functions even at high loads and can be fitted in a simple manner. A further object of the invention is to provide a planetary gear configuration with improved functions, improved tooth engagements, and with good manufacturing characteristics.

With the foregoing and other objects in view there is provided, in accordance with the invention, an adjusting device, in particular an adjusting device for a seat, and preferably an adjusting device for a vehicle seat, including:

a planetary gear including a sun wheel, planet wheels, and a gear housing;

the gear housing having a first housing part and a second housing part, the first housing part having a first internal toothing and a first edge flange, the second housing part having a second internal toothing and a second edge flange; and

a separate retaining ring engaging over the first and second edge flanges and holding the first and second housing parts captively on one another such that the first and second housing parts are rotatable relative to one another.

In other words, the object of the invention is achieved by an adjusting device for the rotational adjustment of two centrically mounted adapter elements, in particular for a seat preferably of a motor vehicle, having a planetary gear which has a sun wheel and planet wheels, the planetary gear being provided with a gear housing having a first housing part with a first internal toothing and a second housing part with a second internal toothing, the housing parts being rotatable relative to each other and being held captively on each other, wherein the two housing parts each have an edge flange, and wherein a separate retaining ring is provided which engages over the edge flanges and holds the housing parts together.

The adjusting device according to the invention has a number of advantages. First of all, it is readily possible in the case of the embodiment according to the invention to rotate the housing parts relative to each other through 360° or more. A striking of the one housing part against the other housing part cannot occur during the rotation. A gaping-apart of the housing parts can also not occur. In addition, by transmitting forces to the entire housing, it is possible to configure the housing of the adjusting device overall with smaller wall thicknesses, which, in turn, has the consequence of a considerable advantage in terms of weight with respect to the conventional adjusting device.

Moreover, adequate sealing of the planetary gear and of the individual gear wheels of the planetary gear can be obtained by the encircling retaining ring. However, the retaining ring not only transmits high forces and seals automatically, it is also very cost-effective to produce and is simple to fit. In addition, a substantial advantage of the invention is that a modular constructional unit is available, to which the adapter elements which are required are fastened as the need arises. In comparison with the adjusting device disclosed in German Patent No. DE 32 01 309 C2, the fitting tabs or the adapter elements are no longer integrally formed with the housing parts. The adjusting device according to the invention can therefore be used for the particular application. In addition to the use in seats in the automobile industry, the use in office furniture, for example, is also suitable. Furthermore, the constructional unit according to the invention can be used both for the adjustment of the seat back and also for the seat height.

The use of a retaining ring as a separate component has the substantial advantage that the housing parts can be configured entirely with regard to their functions in conjunction with the configuration of the planetary gear, on the one hand, and with the absorption of the forces which occur, on the other hand, while in terms of its type of material and on the material thickness used, the retaining ring has to be coordinated exclusively with the retaining function.

The installation of the retaining ring can be realized in a particularly simple manner by the retaining ring being crimped over the edge flanges. A crimping of this type can be undertaken simply and cost-effectively and can readily be integrated into the production and installation process.

Furthermore, when crimping the retaining ring there is no risk of one of the housing parts being detrimentally affected, as is the case in Published, Non-Prosecuted German Patent Application No. DE 199 33 895 A1 where one of the housing parts as such has the crimped edge.

The manner in which the adapter elements are connected to the respective housing parts is of particular importance. Apart from a screw connection, a laser welding connection is especially suitable. A welding connection of this type can be undertaken very rapidly and can readily be used in mass production. It is important in this connection that it can be ensured through the use of the laser welding that there is no “through-welding”, i.e. gear wheels being welded together, or that there is an excessive warping due to heat.

In order to obtain a secure and all-sided fastening of the two housing parts, the edge flanges on the housing parts are of encircling design. Otherwise, the housing parts are identical in terms of their outer shape, with the result that they can be joined together in a simple manner. In addition, identical blanks can be used for both housing parts.

The sealing or adequate protection of the planetary gear against contamination can be obtained in particular by the housing parts each having a solid surface on their outer flat sides, with the exception in each case of a central opening for the insertion of an actuating element into an engagement opening in the sun wheels. This is of importance, for example, when coating or painting it. At the same time, grease cannot escape. Finally, the adjusting device according to the invention as a modular constructional unit constitutes an essentially outwardly closed subassembly. The cup-like configuration in the case of the housing parts and connection to the retaining ring furthermore result in a very stiff housing via which the radial and axial forces which occur can be reliably absorbed. This configuration also means that the adjusting device cannot buckle via the central axis, which is a disadvantage of a large number of adjusting devices used in practice.

Moreover, the cup-shaped housing parts can be configured as deep-drawn parts, which can be produced simply and cost-effectively. During the deep-drawing process, the respective internal toothing can also readily be realized. By deep-drawing the internal toothing, toothing regions which are used in the invention are produced on the outer sides of the housing parts. That is to say, toothing regions corresponding to these toothing regions are provided on the adapter elements. When the adapter elements are fitted onto the housing parts, the individual teeth of the toothing regions engage in one another. Thus, first of all the positioning of the adapter elements is facilitated. Secondly, the form-fitting connection enables forces to be absorbed and transmitted in the radial and circumferential direction, which has an effect in turn on the previously mentioned laser welding connection. This is because, in this case, the laser welding connection only needs to be configured for absorbing axial forces. This concept is otherwise also of independent significance.

Planetary gears of the type discussed here have a high degree of self-locking. In order to ensure self-locking of the planetary gear even in extreme cases, a further device in this regard is provided. In the case of a particularly simple refinement, the device for self-locking has at least one spring device acting on the sun wheel and/or on a planet wheel. It is favorable in this case that the spring device is disposed between a housing part and the sun wheel or a planet wheel and is therefore part of the constructional unit. For space reasons, a disk spring is provided as the spring device, the disk spring being very narrow and preferably acting on the sun wheel, since the greatest locking effect is obtained here. The spring device is used furthermore not only for the self-locking, but for evening out or smoothing out the movement of the planetary gear. In particular in the case of spur toothings, the planetary gear is not perceived as smooth when being operated and has a certain tugging feel. The spring loading means that this tugging feel is practically not perceived by the user.

In order to ensure in the case of the adjusting device according to the invention that, as is also provided in the case of the adjusting device disclosed in German Patent No. DE 32 01 309 C2, all of the forces and moments are neutralized at the tooth which is in engagement, i.e. that the configuration is selected overall in such a manner that the sum of all the acting forces and moments is zero, it can also be provided in the case of the adjusting device according to the invention that the first internal toothing and the second internal toothing have identical operating pressure angles. This is ultimately achieved in an identical manner as is the case with the adjusting device disclosed in German Patent No. DE 32 01 309 C2. In this respect, reference is expressly made thereto, so that the disclosure in this regard becomes the subject matter of the present application.

In terms of handling, it is particularly advantageous that the planet wheels engage in the respective internal toothings and/or the sun wheel in a manner free of play. The freedom from play or backlash can be realized in a particularly simple manner in that the sun wheel and/or the planet wheels and/or the internal toothing are selected by measuring and pairing them. In order to be able to realize a high introduction of force and absorption of force of the individual gear wheels, it is appropriate to design the respective toothings of the planetary gear as a helical toothing or as a herringbone toothing. This results in a relatively high overlap or contact, so that very high forces can be absorbed, which is particularly advantageous if the adjusting device according to the invention is used at points at which correspondingly high forces occur. If, in the case of certain applications, large forces do not occur, the helical or herringbone toothing may nevertheless be appropriate, since then not only is a high safety provided, but in principle also materials which are of lesser quality and are therefore more cost-effective can be used.

With the objects of the invention in view there is also provided, a seat, including:

a seat bottom;

a backrest;

at least two adjusting devices connected to the seat bottom and the backrest, each of the adjusting devices including a planetary gear with a sun wheel, planet wheels, and a gear housing; the gear housing having a first housing part and a second housing part, the first housing part having a first internal toothing and a first edge flange, the second housing part having a second internal toothing and a second edge flange; and a separate retaining ring engaging over the first and second edge flanges and holding the first and second housing parts captively on one another such that the first and second housing parts are rotatable relative to one another.

According to another feature of the invention, the seat bottom and the backrest form an armchair.

With the objects of the invention in view there is also provided, an adjusting device, including:

a planetary gear including a sun wheel, planet wheels, and a gear housing;

the gear housing having a first housing part and a second housing part, the first housing part having a first internal toothing, the second housing part having a second internal toothing;

the first and second housing parts being held captively on one another such that the first and second housing parts are rotatable relative to one another;

the first and second housing parts having respective outer flat sides and toothing regions on the outer flat sides; and

two centrically mounted adapter elements respectively fastened to the first and second housing parts, the adapter elements having toothing regions corresponding to the toothing regions on the outer flat sides of the first and second housing parts, and the adapter elements being rotationally adjustable with respect to one another.

With the objects of the invention in view there is also provided, an adjusting device, including:

a planetary gear including a sun wheel, planet wheels, and a gear housing;

the gear housing having a first housing part and a second housing part, the first housing part having a first internal toothing, the second housing part having a second internal toothing;

the first and second housing parts being held captively on one another such that the first and second housing parts are rotatable relative to one another; and

a locking device for self-locking the planetary gear.

With the objects of the invention in view there is further provided, a gear configuration, including:

a planetary gear including a sun wheel, a given number of planet wheels, and two ring gears;

a first one of the two ring gears having a first number of teeth, a second one of the two ring gears having a second number of teeth, the first number being different from the second number such that a difference between the first number and the second number is dividable by the given number of the planet wheels;

the planetary gear having involute toothings with given operating pressure angles;

the planet wheels having teeth with respective front and rear flanks, the planet wheels meshing with the ring gears such that teeth engagements on the front and rear flanks are facilitated by a profile correction in a toothing of the ring gears; and

a respectively engaged one of the teeth of each of the planet wheels meshing on a respective one of the front flanks with a respective one of the ring gears at an operating pressure angle α_{w1} of between 13 and 35 degrees.

The operating pressure angles specified are suitable for achieving the above-mentioned object of the invention. Through the use of these operating pressure angles α_{w} according to the invention at the front flank and at the rear flank of the respectively engaged tooth of each planet wheel on the two ring gears, a uniform rolling-off of the toothing with small differences in moment is obtained, which makes possible a trouble-free and functionally reliable actuation of the planetary gear with favorable manufacturing parameters.

Particularly in the case of operating pressure angles α_{w1} between 13 and 15 degrees and in particular approximately 14.5 degrees and α_{w2} between 28 and 31 degrees and in particular of approximately 29.5 degrees at the front and rear flanks of the respectively engaged tooth of the respective planet wheel and with a profile contact ratio (transverse contact ratio) ε_{α}>1, excellent tooth engagement and rolling-off ratios are achieved which ensure a play-free and nevertheless smooth-running actuation of the gear.

In terms of manufacture, the toothings of sun wheel and/or planet wheels and/or the ring gears are particularly advantageously configured as spur toothings, which can be manufactured in large numbers without requiring a cutting by stamping or punching. In principle, however, a helical toothing can also be used.

Within the scope of the possible profile corrections (addendum corrections) and axial distances within the ring gears, changes in the transmission ratios can advantageously be undertaken by interchanging sun wheel and planet wheels with a different number of teeth, in which case the ring gears and extensions thereof advantageously remain unchanged as identical parts. As a result, a relatively large total number of pieces can be configured in a cost-effective manner to individual requirements (for example, for backrest adjustments of the different vehicle manufacturers).

If the self-locking of the above-described planetary gear is not adequate for the particular use, a friction brake, for example in the form of a disk spring, which reinforces the self-locking may be provided.

In order to actuate the adjusting device according to the invention or for the drive as a planetary gear, there are two basic possibilities per se, namely, firstly, manually—for example via a handwheel—and, secondly, via an electric motor. The adjusting device is preferably assigned to the sun wheels. In every case, the invention makes it possible to use electric motors having a very small output for the adjustment, since, as has been described, the forces for adjusting the adjusting device according to the invention are very small.

According to another feature of the invention, the friction brake includes at least one disk spring disposed between the sun wheel and one of the ring gears.

Other features which are considered as characteristic for the invention are set forth in the appended claims.

Although the invention is illustrated and described herein as embodied in a adjusting device for a rotational adjustment of two centrically mounted adapter elements, in particular for a seat and preferably for a motor vehicle seat, and a planetary gear for this adjusting device, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic perspective view of a seat having two adjusting devices according to the invention;

FIG. 2 is a diagrammatic exploded view of an adjusting device according to the invention;

FIG. 3 is a diagrammatic plan view of an assembled adjusting device according to the invention;

FIG. 4 is a diagrammatic cross-sectional view of the adjusting device from FIG. 3 along the section line IV-IV;

FIG. 5 is a diagrammatic plan view of the adjusting device from FIG. 3 in the direction of arrow V;

FIG. 6 is a diagrammatic perspective view of the adjusting device from FIG. 3;

FIG. 7 is a diagrammatic, central longitudinal sectional view of a planetary gear with a sun wheel, three planet wheels and two ring gears according to the invention;

FIG. 8 is a diagrammatic exploded view of the planetary gear according to FIG. 7;

FIG. 9 is a partial view of a detail of the toothing engagement relations between a planet wheel and one of the ring gears; and

FIG. 10 is a partial view of a detail of the toothing engagement relations between a planet wheel and another one of the ring gears.

### DESCRIPTION OF THE PREFERRED EMBODIMENTS

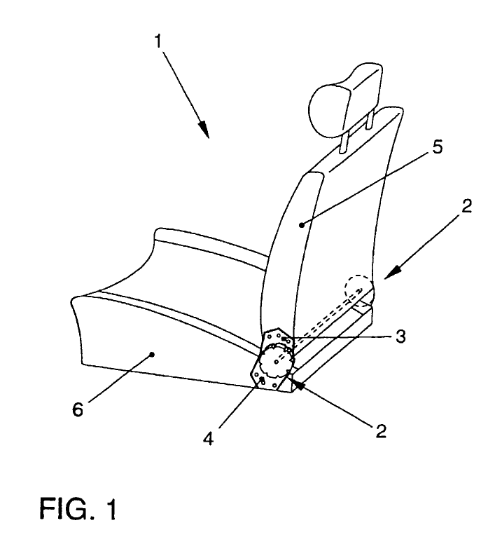

Referring now to the figures of the drawings in detail and first, particularly, to FIG. 1 thereof, there is shown a seat 1 which is provided with two adjusting devices 2. It should be pointed out here that in FIG. 1 only one possible exemplary embodiment of the use of the adjusting device 2 according to the invention is illustrated. Further possible uses of the adjusting device 2 according to the invention are disclosed, for example, in the figures of German Patent No. DE 32 01 309 C2. Reference is expressly made hereby to these uses and German Patent No. DE 32 01 309 C2 is expressly made the subject matter of the present application. Otherwise, however, uses are also possible which are not shown in the above-mentioned German patent, for example for the adjustment of pivoted flaps in aircraft or else in conjunction with office furniture.

The adjusting device 2 is used for the rotational adjustment of two centrically mounted adapter elements 3, 4. In the exemplary embodiment illustrated, the adapter elements 3, 4 are fitting parts which are fastened, on the one hand, to the backrest 5 and, on the other hand, to the seat part 6 of the seat 1.

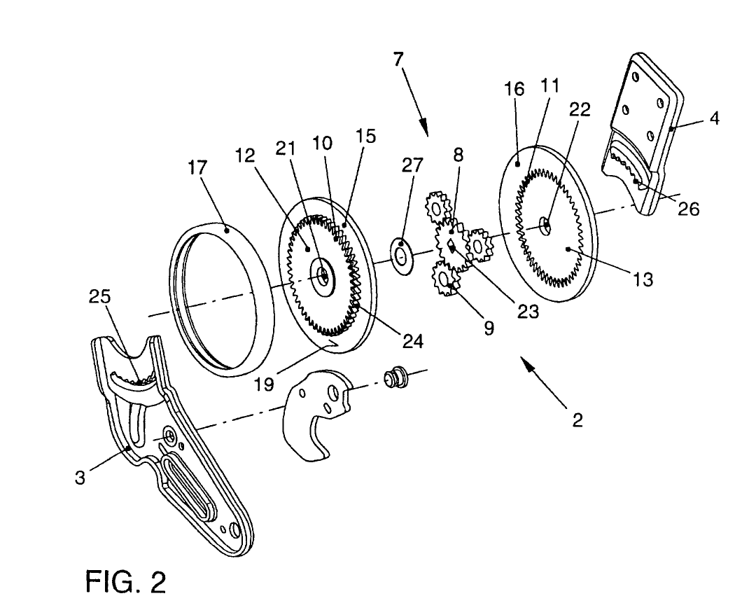

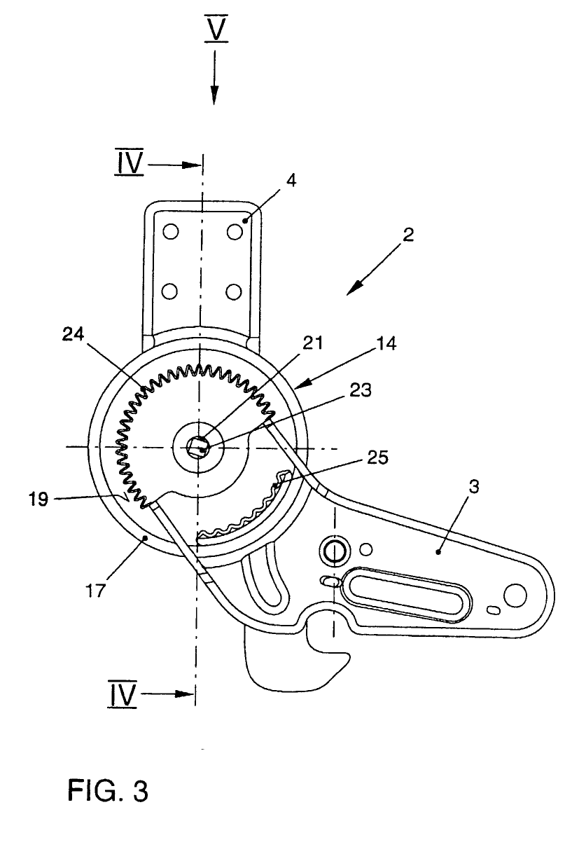

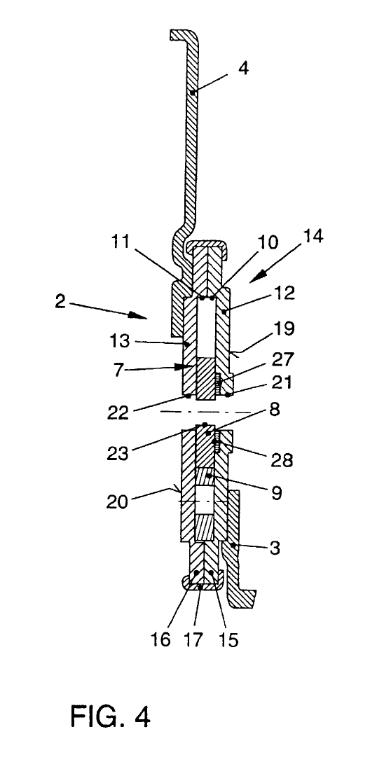

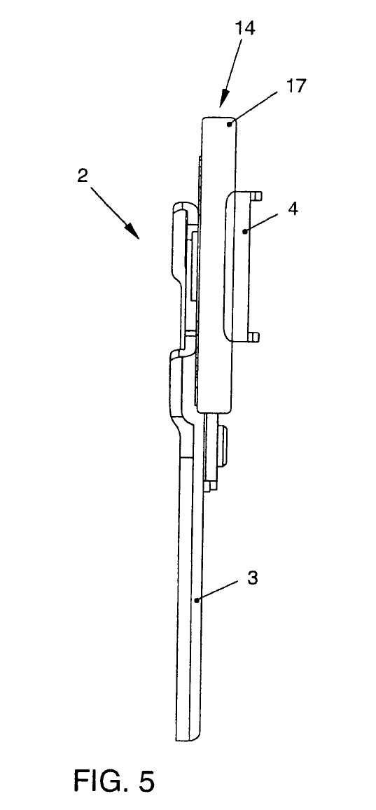

As revealed in FIGS. 2 and 4, the adjusting device 2 has a planetary gear 7. The planetary gear 7 here has a sun wheel 8 and three planet wheels 9 meshing with the sun wheel 8. Furthermore, the planetary gear 7 has a first internal toothing 10 and a second internal toothing 11. In this case, the first internal toothing 10 is provided on a first housing part 12 while the second internal toothing 11 is provided on a second housing part 13. The housing parts 12, 13 are in each case of cup-like design and not only form the gear housing 14 of the planetary gear 7, but also the housing of the adjusting device 2 itself. The gear housing 14 is configured overall in such a manner that the housing parts 12, 13 can be rotated relative to each other and are held captively on each other in the axial direction.

It is essential, first of all, that the two housing parts 12, 13 each have an edge flange 15, 16 and that a separate retaining ring 17 is provided which engages over the edge flanges 15, 16 and holds the housing parts 12, 13 together. The retaining ring 17 is configured in such a manner that it holds the two housing parts 12, 13 together both in the axial and in the radial direction. Through the use of the retaining ring 17 holding the two housing parts 12, 13 together, a modular constructional unit is produced, to which the adapter elements 3, 4, which are configured as separate components, can be fastened.

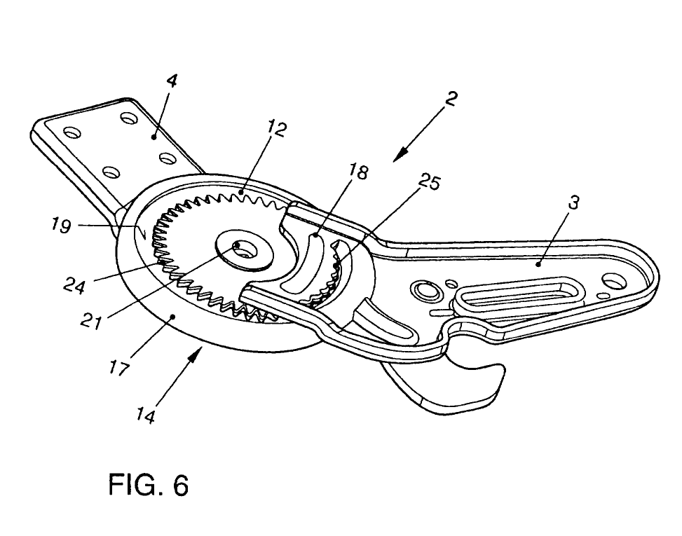

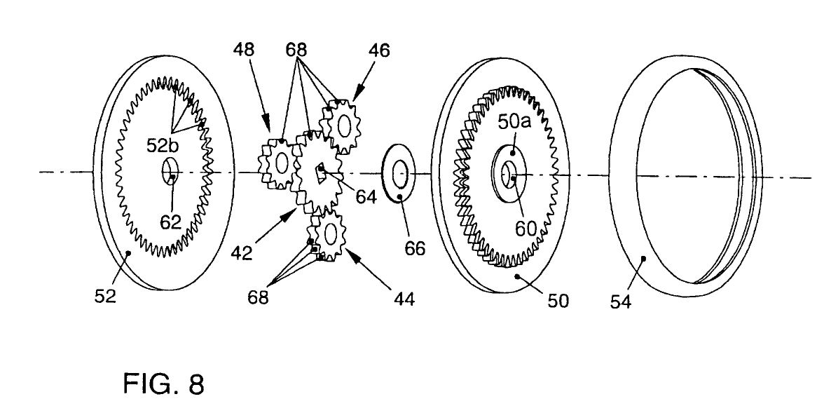

In the present case, the two adapter elements 3, 4 are laser-welded to the housing parts 12, 13. FIG. 6 shows a laser welding connection 18 with regard to the adapter element 3. The adapter element 4 is welded in a similar manner. Alternatively or in addition, a screw connection may be provided, which is schematically indicated as a dashed line 69 in FIG. 8.

The retaining ring 17 is, as is revealed in particular in FIG. 4, crimped at its two edges over the edge flanges 15, 16. The retaining ring 17 is thus not directly fastened to any of the housing parts. Furthermore, in contrast to the illustration according to FIG. 2 in which the end edges of the retaining ring 17 have already been bent downward, the retaining ring 17 can also be configured as a simple pipe section whose one outer end edge is initially angled. In a later process step, the other end edge is also angled. This will be discussed in greater detail below.

As is also revealed in particular in FIG. 2, the edge flanges 15, 16 are of encircling design. FIG. 4 makes it clear that the housing parts 12, 13 are identical in terms of their outer shape. The housing parts 12, 13 each have a solid surface on their outer flat sides 19, 20, with the exception in each case of a central opening 21, 22 for the insertion of an actuating element into an engagement opening 23 in the sun wheel 8 of the planetary gear 7. The actuating element 24 may be a torque rod, the ends of which are used in the manner of a square for insertion into the engagement opening 23.

In the present case, the internal toothings 10, 11 of the planetary gear 7 are of integral design with the housing parts 12, 13, in other words the internal toothing and the housing part forms a one-piece element. The housing parts 12, 13 themselves are deep-drawn parts, the internal toothings 10, 11 also having been deep-drawn during the deep-drawing process for producing the cup shape of the housing parts 12, 13. In this connection, it should be pointed out that the number of teeth of the first internal toothing 10 is not equal to the teeth of the second internal toothing 11. In the exemplary embodiment illustrated, the number of teeth of the second internal toothing 11 is greater by 3 than the number of teeth of the first internal toothing 10.

In the case of the adjusting device 2, provision can be made for all of the forces and moments at the tooth which is in engagement to be neutralized, at least substantially in any case. The freedom from forces is achieved by using a toothing with ever constant engagement ratios, the operating pressure angles always being the same. The freedom from moments is achieved by the operating pitch circles of the internal toothings 10, 11 being identical, i.e. the toothings also having the same pitch points. With regard to the details of this configuration of the adjusting device 2 which is essentially free from forces and moments, reference is expressly made to German Patent No. DE 32 01 309 C2 which is hereby made part of the present application in this respect.

Otherwise, in the case of the adjusting device 2, the planet wheels 9 and the internal toothings 10, 11 can in each case have the same pitch, i.e. the same module, so that there are no pitch errors.

As furthermore results from the individual figures, toothing regions 24 are provided on the outer flat sides 19, 20 of the housing parts 12, 13. Toothing regions 25, 26 corresponding to the toothing regions 24 are provided on the adapter elements 3, 4. It should be pointed out that it goes without saying that, instead of the toothing regions, regions configured in a different manner are also possible, the regions ensuring a form-fitting connection in the radial and circumferential direction between the adapter elements 3, 4 and the housing parts 12, 13. The use of toothing regions 24 on the housing parts 12, 13 and the corresponding toothing regions 25, 26 on the adapter elements 3, 4 is therefore particularly appropriate, since during the deep-drawing of the housing parts 12, 13 together with the respective internal toothings 10, 11, the outer toothing regions 24 are in any case produced on the outer flat sides 19, 20. In the case of the invention, these toothing regions 24 are used as a fitting aid for the adapter elements 3, 4 and for absorbing tangential forces while the respective laser welds 18 for the adapter elements 3, 4 can be of correspondingly smaller dimensions, since the laser welds 18 merely have to absorb axial forces.

Furthermore, the adjusting device 2 has a device for the self-locking of the planetary gear 7. For this purpose, in principle at least one spring device is provided which acts on the sun wheel 8 and/or on at least one planet wheel 9. In this particular case, a disk spring 27 is provided as the spring device, the disk spring being arranged between a housing part, in the present case the housing part 12, and the sun wheel 8.

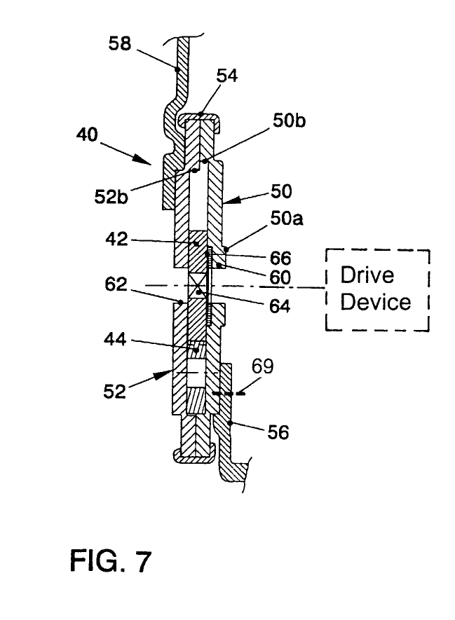

For this purpose, a recess 28 in this regard, into which the disk spring 27 is inserted, is provided in the housing part 12. The depth of the recess 28 is selected in such a manner that the disk spring 27 acts on the sun wheel 8 with a comparatively small spring force, so that the torque on the sun wheel and therefore on the particular actuating element (handwheel or electric motor shown schematically as drive device in FIG. 7) is only increased a little. Furthermore, the spring loading of the sun wheel 8 prevents an axial movement of the sun wheel in the gear housing 14. There is therefore freedom from play in the axial direction.

The planet wheels 7 engage in the internal toothings 10, 11 and in the sun wheel 8 in a manner free from play or backlash. The freedom from play is obtained by the sun wheel 8 and/or the planet wheels 9 being selected by measuring and pairing them. Otherwise, it is illustrated that the individual toothings of the planetary gear 7 are configured as a spur toothing. However, it is also possible to select a helical toothing or even a herringbone toothing.

The installation or the assembly of the adjusting device 2 according to the invention takes place in such a manner that first of all an annular or tubular retaining ring is beveled at one end on the edge. The first housing part 12 is then inserted into the beveled ring. The flange 15 then rests on the tilted part of the retaining ring 17. Subsequently, the disk spring 27 is inserted into the recess 28. The sun wheel 8 and the planet wheels 9 are then inserted into the cup-like, first housing part 12. The gear housing 14 is then closed by placing on the second housing part 13. Subsequently, the retaining ring 17 is crimped at its other end around the edge flange 16 of the second housing part 13. The adapter elements 3, 4 are then positioned depending on the intended application, the toothing regions 24, on the one hand, and 25, 26, on the other hand, engaging in one another. The laser welding of the adapter elements 3, 4 onto the housing parts 12, 13 then takes place.

In FIGS. 7 and 8, 40 denotes a planetary gear which essentially has a sun wheel 42, three planet wheels 44, 46, 48 and two internally toothed ring gears 50, 52. Arranged on the outer circumference of the circular symmetrical ring gears 50, 52 is a retaining ring 54 which holds the latter against each other, but permits relative rotations. Furthermore, fittings 56, 58 are fastened to the ring gears 50, 52, the one fitting 56 of which is formed in a fixed position, for example on a vehicle seat, and the other fitting 58 of which is formed on a backrest belonging to the seat.

The ring gears 50, 52 are provided with a centric hole 60, 62 in which a drive shaft is mounted rotatably, the drive shaft driving the sun wheel 42 during adjusting movements via a polygonal socket 64 in the sun wheel 42.

Clamped between the sun wheel 42 and the hub projection 50a of the ring gear 50 as a friction brake is a disk spring 66 which prestresses the sun wheel 42 against the opposite ring gear 52.

The planet wheels 44, 46, 48, which are distributed in each case at 120 degrees over the circumference of the sun wheel 42 and are arranged without a mounting or a planet wheel web, mesh, on the one hand, with the sun wheel 42 and, on the other hand, in each case with half of their tooth width, with the internal toothings 50b and 52b. The difference in the number of teeth of the internal toothings with respect to each other is three here, corresponding to the number of planet wheels.

The toothings (teeth 68) of the sun wheel 42 and planet wheels 44, 46, 48 and the internal toothings 50b and 52b of the ring gears 50, 52 are preferably produced here without cutting as involute toothings and spur toothings, the internal toothings 50b, 52b being shaped out of the disk-shaped ring gears 50, 52 by precision stamping, while the toothings of sun wheel 42 and planet wheels 44, 46, 48 are manufactured by punching them out of a blank.

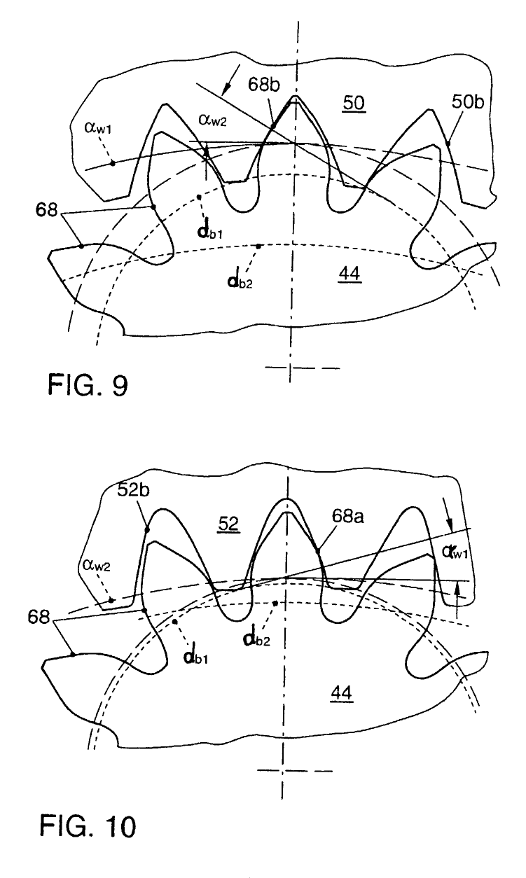

In FIGS. 9 and 10, the engagement ratios between the one planet wheel 44 and the one ring gear 50 and its internal toothing 50b (FIG. 9) and the second ring gear 52 and its internal toothings 52b can be seen.

It can readily be seen that the degree of contact (engagement factor) is ε_{α}>1; furthermore, the operating pressure angle α_{w1} on the front flank 68a of the relevant tooth 68 on the ring gear 52 (FIG. 10) is approximately 14.5 degrees, and the operating pressure angle α0_{w2} on the rear flank 68b of the relevant tooth 68 is approximately 29.5 degrees. This is achieved by the profile corrections on the two ring gears 50, 52 and by the different pitch circles d_{w}.

It is characteristic in this case that in spite of a large difference in the number of teeth of the two ring gears 50, 52 of, for example, three, and therefore the greatly different base circles d_{b2} in FIG. 9 and d_{b2} in FIG. 10, the base circle of the planet wheels 44, 46, 48 d_{b1} intersects the two base circles of the ring gears 50, 52, so that lines of engagement are produced as tangents on the two base circles d_{b1}- d_{b2} (in FIG. 9) and d_{b1}- d_{b2} (in FIG. 10).

Through the use of a selected tooth-head height of the planet wheels 44, 46, 48, a profile contact with the two ring gears 50, 52 of ε_{α}>1 is achieved. The profile correction of the planet wheels 44, 46, 48 is selected in such a manner that a profile contact ε_{α}>1 is also produced for the gear wheel pairing of sun wheel 42 and planet wheels. A uniform, functionally reliable tooth-wheel drive is therefore implemented here.

We claim:

1. An adjusting device, comprising:
a planetary gear including a sun wheel, planet wheels, and a gear housing;
said gear housing having a first housing part and a second housing part, said first housing part having a first internal toothing and a first edge flange, said second housing part having a second internal toothing and a second edge flange; and
a separate retaining ring engaging over said first and second edge flanges and holding said first and second housing parts captively on one another such that said first and second housing parts are rotatable relative to one another.

2. The adjusting device according to claim 1, including:
two centrically mounted adapter elements configured as separate components, said adapter elements being rotationally adjustable to one another and respectively fastened to said first and second housing parts; and
said planetary gear and said adapter elements forming a modular constructional unit.

3. The adjusting device according to claim 1, wherein said retaining ring is crimped over said first and second edge flanges.

4. The adjusting device according to claim 2, wherein said adapter elements are respectively connected to said first and second housing parts via a connection selected from the group consisting of a laser welding connection and a screw connection.

5. The adjusting device according to claim 1, wherein said first and second edge flanges are encircling edge flanges.

6. The adjusting device according to claim 1, wherein said first and second housing parts have substantially identical outer shapes.

7. The adjusting device according to claim 1, wherein:
said sun wheel of said planetary gear has an engagement opening formed therein; and
each of said first and second housing parts has an outer flat side with a central opening formed therein, said central opening is configured to receive an actuating device to be inserted into said engagement opening of said sun wheel.

8. The adjusting device according to claim 1, wherein each of said first and second housing parts forms, together with a respective one of said first and second internal toothings, a one-piece element.

9. The adjusting device according to claim 1, wherein said first and second housing parts are deep-drawn parts.

10. The adjusting device according to claim 1, including a locking device having at least one spring device acting on at least one wheel selected from the group consisting of said sun wheel and said planet wheels for self-locking said planetary gear.

11. The adjusting device according to claim 10, wherein said at least one spring device is disposed between one of said first and second housing parts and a wheel selected from the group consisting of said sun wheel and said planet wheels.

12. The adjusting device according to claim 10, wherein said at least one spring device is a disk spring.

13. The adjusting device according to claim 1, wherein said first internal toothing has a first number of teeth, said second internal toothing has a second number of teeth different from said first number of teeth.

14. The adjusting device according to claim 1, wherein said planet wheels engage in said first and second internal toothings such that there is no play between said planet wheels and said first and second internal toothings.

15. The adjusting device according to claim 1, wherein said planet wheels engage in said sun wheel such that there is no play between said planet wheels and said sun wheel.

16. The adjusting device according to claim 1, wherein at least one wheel selected from the group consisting of said sun wheel and said planet wheels is selected by one of measuring and mating said at least one wheel.

17. The adjusting device according to claim 1, wherein said first and second internal toothings are toothings selected from the group consisting of helical toothings and herringbone toothings.

18. The adjusting device according to claim 1, including a drive device operatively connected to said sun wheel, said drive device being a device selected from the group consisting of a manually operable handwheel and an electric motor.

19. In combination with a seat having a seat bottom and a backrest, an adjusting device according to claim 2, wherein said adapter elements are respectively connected to the seat bottom and the backrest.

20. A seat, comprising:
a seat bottom;
a backrest;
at least two adjusting devices connected to said seat bottom and said backrest, each of said adjusting devices including:
a planetary gear with a sun wheel, planet wheels, and a gear housing;
said gear housing having a first housing part and a second housing part, said first housing part having a first internal toothing and a first edge flange, said second housing part having a second internal toothing and a second edge flange; and
a separate retaining ring engaging over said first and second edge flanges and holding said first and second housing parts captively on one another such that said first and second housing parts are rotatable relative to one another.

21. The seat according to claim 20, wherein the seat bottom and the backrest form an armchair.

22. An adjusting device, comprising:
a planetary gear including a sun wheel, planet wheels, and a gear housing;
said gear housing having a first housing part and a second housing part, said first housing part having a first internal toothing, said second housing part having a second internal toothing;
said first and second housing parts being held captively on one another such that said first and second housing parts are rotatable relative to one another;
said first and second housing parts having respective outer flat sides and toothing regions on said outer flat sides; and two centrically mounted adapter elements respectively fastened to said first and second housing parts, said adapter elements having toothing regions corresponding to said toothing regions on said outer flat sides of said first and second housing parts, and said adapter elements being rotationally adjustable with respect to one another.

23. An adjusting device, comprising:
a planetary gear including a sun wheel, planet wheels, and a gear housing;
said gear housing having a first housing part and a second housing part, said first housing part having a first internal toothing, said second housing part having a second internal toothing;
said first and second housing parts being held captively on one another such that said first and second housing parts are rotatable relative to one another; and
a locking device for self-locking said planetary gear.

24. A gear configuration, comprising:
a planetary gear including a sun wheel, a given number of planet wheels, and two ring gears;
a first one of said two ring gears having a first number of teeth, a second one of said two ring gears having a second number of teeth, said first number being different from said second number such that a difference between said first number and said second number is dividable by the given number of said planet wheels;
said planetary gear having involute toothings with given operating pressure angles;
said planet wheels having teeth with respective front and rear flanks, said planet wheels meshing with said ring gears such that teeth engagements on said front and rear flanks are facilitated by a profile correction in a toothing of said ring gears; and
a respectively engaged one of said teeth of each of said planet wheels meshing on a respective one of said front flanks with a respective one of said ring gears at an operating pressure angle of between 13 and 35 degrees.

25. The gear configuration according to claim 24, wherein said planetary gear is configured such that the operating pressure angle on said respective one of said front flanks is between 13 and 15 degrees.

26. The gear configuration according to claim 24, wherein said planetary gear is configured such that the operating pressure angle on said respective one of said front flanks is between 20 and 35 degrees.

27. The gear configuration according to claim 24, wherein said planetary gear is configured such that the operating pressure angle on said respective one of said front flanks is substantially 14.5 degrees.

28. The gear configuration according to claim 24, wherein said planetary gear is configured such that an operating pressure angle on a respective one of said rear flanks is between 28 and 31 degrees.

29. The gear configuration according to claim 24, wherein said planetary gear is configured such that an operating pressure angle on a respective one of said rear flanks is substantially 29.5 degrees.

30. The gear configuration according to claims 24, wherein said planetary gear is configured such that a profile contact ratio between said planet wheels and said two ring gears and between said planet wheels and said sun wheel is larger than one.

31. The gear configuration according to claim 24, wherein said planetary gear is configured such that different transmission ratios can be set by keeping toothing parameters constant and exchanging said planet wheels and said sun wheel.

32. The gear configuration according to claim 24, wherein said planetary gear includes a friction brake for assisting a self-locking of said planetary gear.

33. The gear configuration according to claim 32, wherein said friction brake includes at least one disk spring disposed between said sun wheel and one of said ring gears.

34. The gear configuration according to claim 24, wherein said involute toothings of said planetary gear are spur toothings.

35. The gear configuration to according to claim 34, wherein at least one of said involute spur toothings is a toothing selected from the group consisting of a stamped toothing, a punched toothing, and a cut toothing.

36. The gear configuration according to claim 24, wherein said involute toothings of said planetary gear are helical toothings.

37. The gear configuration according to claim 24, including:
a first component connected to a first one of said ring gears;
a second component connected to a second one of said ring gears; and
said planetary gear operating as an adjusting mechanism for adjusting said first and second components with respect to one another.
